(19) United States
(12) Patent Application Publication
(10) Pub. No.: US 2016/0310806 A1
(43) Pub. Date: Oct. 27, 2016

(54) DYEING OF GOLF CLUBS

(71) Applicant: NIKE, Inc., Beaverton, OR (US)

(72) Inventor: Michael Wallans, Portland, OR (US)

(73) Assignee: NIKE, INC., Beaverton, OR (US)

(21) Appl. No.: 14/694,558

(22) Filed: Apr. 23, 2015

(51) Int. Cl. A63B 53/04; B05D 1/18

(52) U.S. Cl. CPC A63B 53/04; B05D 1/18; A63B 2209/00

(57) ABSTRACT

A polymeric portion of a golf club head is formed of a first color and is dyed to a second color with an anionic or nonionic disperse dye. The polymeric portion includes a polymeric material that is selected from the group consisting of polyurethanes, polyureas, polyamides, and combinations thereof, which can be dyed by the anionic or nonionic disperse dye.

### TECHNICAL FIELD

The invention is related to methods of dyeing golf clubs and to the dyed golf clubs produced by those methods.

### BACKGROUND

This section provides background information related to this disclosure but which may or may not be prior art.

Zhao et al., U.S. Pat. Nos. 5,938,828 and 5,948,152 disclose complexes of anionic organic dyes with quaternary ammonium compounds, particularly with alkoxylated moieties. Unwanted salts formed from the cations of the dye and counterions are removed to obtain a dyeing agent that easily disperses within different media and possesses favorable non-migration and coloring characteristics. The examples disclosed include a complex of acid red with dicoco dimethyl ammonium chloride; a complex of direct blue with ditallow dimethyl ammonium chloride; and complexes of direct blue, acid red, acid yellow, and quinoline yellow with methyl bis[polyethoxy (15) ethanol]coco ammonium chloride.

Various patents disclosing novel anionic dyes, for example Benguerrel, U.S. Pat. No. 4,384,870; Uehlinger, U.S. Pat. No. 4,466,920; Schoefberger, U.S. Pat. No. 5,354,849; and Benguerrel, Swiss Patent CH 635 361 generally disclose anionic dyes with various counterions and mention polyurethane textiles as substrates that can be dyed with the anionic dyes.

Acid dyes are generally used to dye protein fibers such as wool and silk and to dye polyamide (nylon) fibers. Acid dyes are known to have less success dyeing other materials. For instance, Haerri et al., WO 2011/035533 describes dyeing textile blends of polyamide and elastane (also known as spandex and which has both urethane and urea linkages) fibers by adding a combination of a betaine, quaternary ammonium salt, and alkoxylated fatty alcohol as a shade enhancing agent to the dye liquor to diminish the shade difference between the polyamide and elastane fibers. B. H. Patel et al., “Dyeing of polyurethane fibre with acid dyes,” The Indian Textile Journal (September 2009) notes shortcomings in colorfastness.

Clothing, accessories, or athletic equipment are often a source of expression for the athlete. The clothing, accessories, or athletic equipment may be colored or marked to provide an association with an event, team, or business, coordinate with another item, or provide the owner or user with an attractive or customized item.

Golf clubs are typically formed from a metallic material and are adorned with one or more stylistic appliques or painted and glazed to a predetermined color scheme during initial manufacturing. Customization of the style or appearance of a golf club by an end user is not common, and it is expensive to produce and inventory golf clubs with customized color schemes in small quantities.

### SUMMARY

A method of providing a customized color scheme on a golf club head includes providing a golf club head having a polymeric material. The polymeric material is selected from the group consisting of polyurethanes, polyureas, polyamides, and combinations thereof. To dye the polymeric material from a first color to a second color, the polymeric portion is contacted by an aqueous anionic or nonionic disperse dye solution to dye for a period of time that is sufficient to achieve the desired level of coloration.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a golf club head.

FIG. 2 is a schematic flow diagram of a method of customizing a golf club according to a user-specified color scheme.

FIG. 3 is a schematic perspective view of a wood-type golf club head.

FIG. 4 is a schematic perspective view of an iron-type golf club head.

FIG. 5 is a schematic front view of a putter.

FIG. 6 is a schematic perspective view of the sole and rear portion of a putter.

FIG. 7 is a schematic flow diagram of a method of receiving a customized color scheme from a user.

FIG. 8 is a schematic side view of a golf club head immersed in a dye solution.

FIG. 9 is a schematic perspective view of a golf club head masked to expose only a first polymeric portion of the head.

FIG. 10 is a schematic perspective view of a golf club head masked to expose only a second polymeric portion of the head.

### DETAILED DESCRIPTION

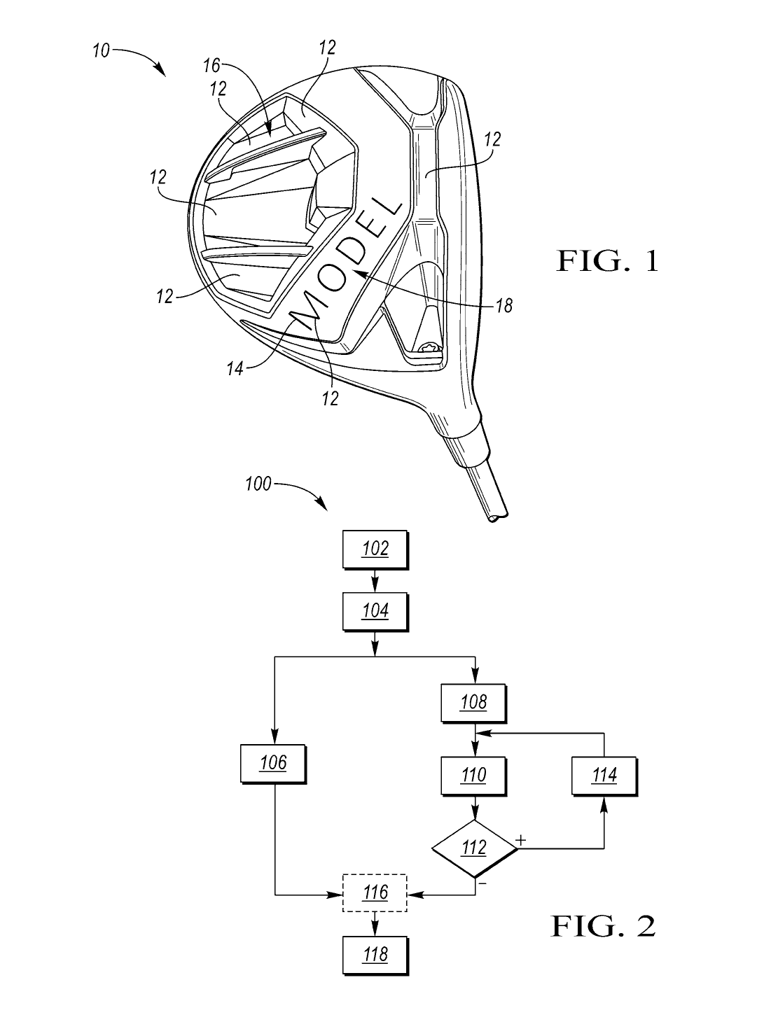

Referring to the drawings, wherein like reference numerals are used to identify like or identical components in the various views, FIG. 1 schematically illustrates a golf club head 10 that includes at least one polymeric portion 12 capable of being dyed according to the present techniques. In one configuration, a polymeric portion 12 may be, for example, a polymeric fill, paint, or coating that is provided in/on a recessed groove 14 or an area 16, a polymeric insert or applique that is mechanically or chemically affixed to the club head 10, or a comolded portion of the club head 10 itself.

The present disclosure provides a method of customizing the golf club head 10 by enabling a user to specify and/or dye each respective polymeric portion 12 according to a user-definable color scheme. More specifically, each polymeric portion 12 may include a polymeric material that may suitably receive a dye following the initial manufacturing of the club head 10. In general, dyeing portions of the club head 10 following initial manufacturing may simplify the overall manufacturing process while eliminating the need to inventory many different color combinations of the same product. Additionally, dyeing in this manner may provide an end consumer with the ability to customize the look and appearance of the club head according to their own personal liking.

The dyeable polymeric portion 12 of the golf club head may be formed from one or more layers that includes at least a dyeable base layer and that optionally includes a coating layer provided over the base layer. In one configuration, the coating layer may be a clear coating and may have a material hardness that is greater than the material used to form the base layer. In this manner, the clear coating may be operative to increase the durability and/or appearance of the exterior finish of the club head. In other embodiments, the coating may be tinted or dyed (e.g., through the present processes) to further alter the look or appearance of the club head 10.

The dyeable base layer comprises at least one of polyurethane, polyurea, and polyamide in an amount sufficient to be dyed with an acid or nonionic disperse dye solution. While such materials are not known to readily accept dyes, the presently described compositions and methods may provide enhanced dye retention, especially with TPU materials.

The one or more polymeric portions 12 of the golf club 10 may be dyed by a process that includes contacting the golf club 10 with the dye solution, for example by partially or fully immersing the golf club 10 in the dye solution for an amount of time that is sufficient for the dye compound to diffuse into the polymer and alter the color of the polymeric portion 12. Other methods of application may include spraying or printing the dye solution onto the polymeric portion in a manner that ensures that the dye solution remains in contact with the club head 10 for the prescribed amount of time. In some embodiments, the dye solution is kept in contact with the polymeric portion 12 for up to about 15 minutes or from about 1 minute or about 2 minutes to about 10 minutes or about 15 minutes.

It is generally observed that, all other things being equal, a polyurethane, polyurea, or polyamide with lower hardness takes a dye more readily than one with higher hardness. Additionally, elevated temperature may aid dyeing by solubilizing the dye and increasing dye diffusion into the dyeable base layer. In certain embodiments, the golf club 10 is dyed in a dye solution at a temperature of from ambient up to about 80° C., or preferably from about 20° C. to about 60° C., or more preferably from about 40° to about 70° C., or from about 30° to about 60° C.

In a first embodiment, the base layer includes the polyurethane, polyurea, or polyamide and is dyed from a first color to a second color. In this embodiment, the polymeric portion 12 has no coating layer disposed over the base layer.

In a second embodiment, the base layer includes the polyurethane, polyurea, or polyamide and is dyed from a first color to a second color, and the polymeric portion 12 has no coating layer during the dyeing. After the base layer is dyed, a clear coating is applied over the dyed base layer, for example to provide a glossy finish to the polymeric portion 12.

In a third embodiment, the base layer is dyed as before from a first color to a second color, and a clear coating layer containing a polyurethane, polyurea, or polyamide is applied over only a portion, but less than all of the dyed base layer, then the applied coating is dyed a third color different from the first and second colors. The portion or portions of the polymeric portion 12 without the clear coating layer may be masked to prevent color change by contact with the acid dye or a nonionic disperse dye used to dye the clear coating. A partial clear coating layer may be applied by pad printing or other printing methods or by masking areas of the base layer that are not to receive the coating (e.g., with a wax or impervious template temporarily adhered to the polymeric portion 12) before applying the clear coating to the base layer.

In various configurations of each of the first through third embodiments, less than all of the base layer may be dyed the second color, for example by only contacting part of the base layer with the anionic dye or nonionic disperse dye solution or by masking a part of the base layer before contacting the base layer with the dye so as to shield the masked part from being dyed.

In a fourth embodiment, a coating layer on the base layer includes the polyurethane, polyurea, or polyamide and the coating layer is dyed from a first color to a second color. The base layer is not dyed.

In a fifth embodiment, a clear coating layer on the base layer includes the polyurethane, polyurea, or polyamide and the coating layer is dyed to a second color. The base layer also include a polyurethane, polyurea, or polyamide and is also dyed to the second color by contacting the polymeric portion 12 with the anionic or nonionic disperse dye solution for time sufficient for the dye to enter both the clear coating layer and to enter at least partially into the base layer.

In various configurations of the fourth and fifth methods, less than all of the clear coating layer may be dyed the second color, for example by only contacting part of the clear coating layer with the anionic dye or nonionic disperse dye solution or by masking a part of the clear coating layer before contacting the clear coating layer with the anionic dye or nonionic disperse dye solution so as to shield the masked part from being dyed.

In a sixth embodiment, the base layer is not dyed and does not contain a polyurethane, polyurea, or polyamide. A partial layer of a clear coating layer containing the polyurethane, polyurea, or polyamide is applied on the base layer by pad printing or other printing methods or by masking areas of the base layer that are not to receive the coating (e.g., with a wax or impervious template temporarily adhered to the polymeric portion 12) before applying the clear coating to the base layer. The applied clear coating portions are then dyed with the anionic dye or nonionic disperse dye solution. The base layer is not dyed by the dye.

While each of the first through sixth embodiments describe how a particular polymeric portion may be dyed, it is also possible for different polymeric portions 12 on the same club to be separately dyed through any one of the six dyeing methods. For example, a first polymeric portion may be dyed a first color through a first method, while any remaining polymeric portions are masked off to prevent dyeing. Following the initial dyeing, the dyed, first polymeric portion may be masked off, and a second polymeric portion may be unmasked and dyed a second color. This process may be repeated until all polymeric portions are dyed to their intended color. In one configuration, the sequential process of dyeing a plurality of polymeric portions may be used to dye a plurality of base layers, and a clear coating may be applied once all dyeing is complete.

In the configuration where a clear coating is applied after the one or more polymeric portions 12 have been dyed, the clear coating is preferably harder than the base layer. As noted above, softer materials have been found to take the dye more readily that harder materials. If left uncoated, a dyed surface that is provided, for example, on the sole of the club, may have a tendency to scuff or discolor following repeated impacts with the ground. Therefore, in some instances, a comparatively harder clear coating or glaze may be applied to enhance the durability of the final club head 10. In other embodiments the base layer may be hardened through a secondary process following the dyeing. For example, the polymeric material of the base layer may include a UV initiator or other cross-link promoter that may be used to cure/cross-link the polymer following the application of the dye.

The invention is further described in the following examples. The example is merely illustrative and does not in any way limit the scope of the invention as described and claimed. All parts are parts by weight unless otherwise noted.

### Acid Dye Composition

Acid dyes are water-soluble anionic dyes. Acid dyes are available in a wide variety, from dull tones to brilliant shades. Chemically, acid dyes include azo, anthraquinone and triarylmethane compounds.

The “Color Index” (C.I.), published jointly by the Society of Dyers and Colourists (UK) and by the American Association of Textile Chemists and Colorists (USA), is the most extensive compendium of dyes and pigments for large scale coloration purposes, including 12000 products under 2000 C.I. generic names. In the C.I. each compound is presented with two numbers referring to the coloristic and chemical classification. The “generic name” refers to the field of application and/or method of coloration, while the other number is the “constitution number.” Nonlimiting examples of acid dyes include Acid Yellow 1, 17, 23, 25, 34, 42, 44, 49, 61, 79, 99, 110, 116, 127, 151, 158:1, 159, 166, 169, 194, 199, 204, 220, 232, 241, 246, and 250; Acid Red, 1, 14, 17, 18, 42, 57, 88, 97, 118, 119, 151, 183, 184, 186, 194, 195, 198, 211, 225, 226, 249, 251, 257, 260, 266, 278, 283, 315, 336, 337, 357, 359, 361, 362, 374, 405, 407, 414, 418, 419, and 447; Acid Violet 3, 5, 7, 17, 54, 90, and 92; Acid Brown 4, 14, 15, 45, 50, 58, 75, 97, 98, 147, 160:1, 161, 165, 191, 235, 239, 248, 282, 283, 289, 298, 322, 343, 349, 354, 355, 357, 365, 384, 392, 402, 414, 420, 422, 425, 432, and 434; Acid Orange 3, 7, 10, 19, 33, 56, 60, 61, 67, 74, 80, 86, 94, 139, 142, 144, 154, and 162; Acid Blue 1, 7, 9, 15, 92, 133, 158, 185, 193, 277, 277:1, 314, 324, 335, and 342; Acid Green 1, 12, 68:1, 73, 80, 104, 114, and 119; Acid Black 1, 26, 52, 58, 60, 64, 65, 71, 82, 84, 107, 164, 172, 187, 194, 207, 210, 234, 235, and combinations of these. The acid dyes may be used singly or in any combination in the dye solution.

Acid dyes and nonionic disperse dyes are commercially available from many sources, including Dystar L.P., Charlotte, N.C. under the trademark TELON, Huntsman Corporation, Woodlands, Tex. under the trademarks ERIONYL and TECTILON, BASF SE, Ludwigshafen, Germany under the trademark BASACID, and Bezema AG, Montlingen, Switzerland under the trade name Bemacid.

Nonionic disperse dyes are also commercially available in many colors and include fluorescent dyes.

The acid or nonionic disperse dye solution in which the polymeric portion 12 is dyed may include, for example, from about 0.001 to about 5.0 g/L, preferably from about 0.01 to about 2 g/L of the acid or nonionic disperse dye compound or combination of acid or nonionic disperse dye compounds. The amount of acid or nonionic disperse dye compound used will determine how strong the color is of the dyed base layer or coating layer and how quickly the base layer or coating layer is dyed, and may be optimized in a straightforward manner; generally, a more concentrated dye solution can provide a stronger (deeper, darker, more intense) dyed color and can more quickly dye the base layer or coating containing polyurethane, polyurea, or polyamide.

The dye solution may include a water-soluble organic solvent. Water solubility of a particular organic solvent used in a particular amount in the dye solution is determined at 20° C. and 1 atm. pressure at the concentration at which the alcohol is to be used in the dye solution; the organic solvent is water soluble if it fully dissolves or is fully miscible in water at 20° C. and 1 atm. pressure at the concentration at which the alcohol is to be used in the dye solution and does not form any separate phase or layer. Suitable, nonlimiting examples of water-soluble organic solvents that may be used include alcohols, such as methanol, ethanol, n-propanol, isopropanol, ethylene glycol, diethylene glycol, triethylene glycol, tetraethylene glycol, propylene glycol, dipropylene glycol, tripropylene glycols, and glycerol; ketones, such as acetone and methyl ethyl ketone; esters, such as butyl acetate, which is soluble in limited amounts in water; and glycol ethers and glycol ether esters (particularly acetates), such as ethylene glycol monobutyl ether, propylene glycol monomethyl ether, and propylene glycol monomethyl ether acetate. The water-soluble organic solvent may be included in concentrations of up to about 50% by volume, or up to about 25% by volume, or from about 1% to about 50% by volume, or from about 5% to about 40% by volume, or from about 10% to about 30% by volume, or from about 15% to about 25% by volume of the aqueous medium used to make the dye solution. Whether an organic solvent is used and how much organic solvent is used may be varied according to which dye is used and to the application method for contacting the dye solution with the polymeric portion. For instance, no or minimal amount of organic solvent may be included in a dye solution into which the polymeric portion is dipped in dyeing, while substantially more organic solvent may be included when the dye is sprayed or printed onto the polymeric portion.

When the base layer or clear coating layer to be dyed includes a material selected from polyurethanes, polyureas, and polyurethane/polyurea blends and copolymers or thermoset products of these, the anionic dye solution also advantageously includes a quaternary (tetraalkyl) ammonium salt selected from soluble tetrabutylammonium compounds and tetrahexylammonium compounds. A polyurethane- or polyurea-containing base layer or clear coating layer may thus be dyed in an acid dye solution including an anionic dye compound, a quaternary ammonium salt selected from soluble tetrabutylammonium compounds and tetrahexylammonium compounds, and, optionally, a water-soluble organic solvent.

The counterion of the quaternary ammonium salt should be selected so that the quaternary ammonium salt forms a stable solution with the anionic dye. The quaternary ammonium compound may be, for example, a halide (such as chloride, bromide or iodide), hydroxide, sulfate, sulfite, carbonate, perchlorate, chlorate, bromate, iodate, nitrate, nitrite, phosphate, phosphite, hexfluorophosphite, borate, tetrafluoroborate, cyanide, isocyanide, azide, thiosulfate, thiocyanate, or carboxylate (such as acetate or oxalate). In certain embodiments, an anion that is a weaker Lewis base may be selected for the tetraalkylammonium compound to produce a darker color for the dyed base layer or coating layer. In various embodiments, the tetraalkylammonium compound is or includes a tetrabutylammonium halide or tetrahexylammonium halide, particularly a tetrabutylammonium bromide or chloride or a tetrahexylammonium bromide or chloride.

The acid dye solution used to dye the base layer or coating layer when it contains a polyurethane or polyurea may include from about 0.1 to about 5 equivalents of the soluble tetraalkylammonium compound per equivalent of dye compound. In various embodiments, the acid dye solution may include from about 0.5 to about 4, preferably from about 1 to about 4 equivalents of the tetraalkylammonium compound per equivalent of dye compound. The amount of tetraalkylammonium compound used with a particular acid dye compound depends upon the rate of diffusion of the dye into and in the base layer or coating layer and may be optimized in a straightforward manner. The process of dyeing a polyurethane- or polyurea-containing base layer or coating layer with the disclosed dye solution containing the soluble tetraalkylammonium compound can produce strong color intensity in the dyed base layer or coating layer.

### Polymeric Portion Composition

The base layer or coating layer that is dyed includes a sufficient amount of one or more of the polyurethane, polyurea, and polyamide polymers to be dyed by the anionic or nonionic disperse dye. In some cases, the base layer or coating layer may include only polyurethane, polyurea, and polyamide polymers and copolymers (including thermoset reaction products); in other cases, the base layer or coating layer contains one or more polyurethane, polyurea, and polyamide polymers, copolymers, and blends as well as one or more different polymers. The base layer or coating may include from about 20% to about 100% by weight, or from about 30% to about 100% by weight, or from about 50% to about 95% by weight of the combined polyurethane, polyurea, and polyamide polymers and copolymers based on total polymer weight in the base layer or coating layer. In other embodiments, the base layer or coating includes at least about 20% by weight, or at least about 30% by weight, or at least about 40% by weight, or at least about 50% by weight, or at least about 60% by weight, or at least about 70% by weight and up to about 90% by weight or up to about 95% by weight or up to about 100% by weight of the combined polyurethane, polyurea, and polyamide polymers and copolymers based on total polymer weight in the base layer or coating layer.

In general terms, suitable polyurethanes include both thermoplastic and thermoset reaction products of one or more polyisocyanates and one or more polyols. A thermoplastic polyurethane results when all or substantially all of the reactants are difunctional (while careful addition of limited amounts of a trifunctional reactant may result in a branched thermoplastic polyurethane, optionally using a monofunctional reactant to help control branching) and no crosslinker or crosslinking agent is employed. A thermoset polyurethane may be obtained by using one or more trifunctional or higher functionality reactants in sufficient amount to obtain a crosslinked product or by crosslinking the polyurethane after polymerization through functionality on the polyurethane, e.g. by reacting terminal isocyanate or hydroxyl groups with a polyfunctional crosslinker or by inducing addition polymerization of ethylenic unsaturation of the polymer, for example as described in Ishii et al., US Patent Application Publ. No. 2012/0225738.

The polyisocyanate may be aromatic or aliphatic. Useful diisocyanate compounds used to prepare thermoplastic polyurethanes include, without limitation, isophorone diisocyanate (IPDI), methylene bis-4-cyclohexyl isocyanate (H12MDI), cyclohexyl diisocyanate (CHDI), m-tetramethyl xylene diisocyanate (m-TMXDI), p-tetramethyl xylene diisocyanate (p-TMXDI), 4,4′-methylene diphenyl diisocyanate (MDI, also known as 4,4′-diphenylmethane diisocyanate), 2,4- or 2,6-toluene diisocyanate (TDI), ethylene diisocyanate, 1,2-diisocyanatopropane, 1,3-diisocyanatopropane, 1,6-diisocyanatohexane (hexamethylene diisocyanate or HDI), 1,4-butylene diisocyanate, lysine diisocyanate, meta-xylylenediioscyanate and para-xylylenediisocyanate, 4-chloro-1,3-phenylene diisocyanate, 1,5-tetrahydro-naphthalene diisocyanate, 4,4′-dibenzyl diisocyanate, and xylylene diisocyanate (XDI), and biurets of these. These may be used in any combination. In certain embodiments MDI may be a preferred diisocyanate. Nonlimiting examples of higher-functionality polyisocyanates that may be used in limited amounts to produce branched thermoplastic polyurethanes (optionally along with monofunctional alcohols) or higher amounts to produce thermoset polyurethanes include 1,2,4-benzene triisocyanate, 1,3,6-hexamethylene triisocyanate, 1,6,11-undecane triisocyanate, bicycloheptane triisocyanate, triphenylmethane-4,4′,4″-triisocyanate, isocyanurates of diisocyanates, biurets of diisocyanates, allophanates of diisocyanates, and isocyanate-functional compounds containing urethane, urea, carbodiimide, or uretdione groups. Polyisocyanates containing urethane groups, for example, are obtained by reacting some of the isocyanate groups with polyols, such as trimethylolpropane, pentaerythritol, and glycerol, for example.

Nonlimiting examples of suitable diols and polyols that may be used include ethylene glycol and lower oligomers of ethylene glycol including diethylene glycol, triethylene glycol and tetraethylene glycol; propylene glycol and lower oligomers of propylene glycol including dipropylene glycol, tripropylene glycol and tetrapropylene glycol; cyclohexanedimethanol, 1,6-hexanediol, 2-ethyl-1,6-hexanediol, 1,4-butanediol, 1,5-pentanediol, 1,3-propanediol, butylene glycol, neopentyl glycol, dihydroxyalkylated aromatic compounds such as the bis(2-hydroxyethyl) ethers of hydroquinone and resorcinol; p-xylene-α,α′-diol; the bis(2-hydroxyethyl) ether of p-xylene-α,α′-diol; m-xylene-α,α′-diol and combinations of these. Thermoplastic polyurethanes may be made using small amounts of triols or higher functionality polyols, such as trimethylolpropane or pentaerythritol, optionally along with monomeric alcohols such as C2-C8 monools, while thermoset polyurethanes may be prepared using sufficient amounts of such amounts of triols or higher functionality polyols to provide a crosslinked product. Generally, aliphatic polyisocyanates and polyols may be used for better resistance to yellowing.

In various embodiments, the polyurethane may be a thermoplastic polyurethane elastomer. The thermoplastic polyurethane elastomer may be selected from thermoplastic polyester-polyurethanes, polyether-polyurethanes, and polycarbonate-polyurethanes, including, without limitation, polyurethanes polymerized using as diol reactants polytetrahydrofurans, polyesters, polycaprolactone polyesters, and polyethers of ethylene oxide, propylene oxide, and copolymers including ethylene oxide and propylene oxide. These polymeric diol-based polyurethanes are prepared by reaction of the polymeric diol (polyester diol, polyether diol, polycaprolactone diol, polytetrahydrofuran diol, or polycarbonate diol), one or more polyisocyanates such as those already mentioned, and, optionally, one or more chain extension compounds. Chain extension compounds, as the term is used herein, are compounds having two or more functional groups reactive with isocyanate groups, such as the polyols already mentioned. Preferably the polymeric diol-based polyurethane is substantially linear (i.e., substantially all of the reactants are difunctional).

The polyester diols used in forming a thermoplastic polyurethane are in general prepared by the condensation polymerization of one or more polyacid compounds and one or more polyol compounds. Preferably, the polyacid compounds and polyol compounds are di-functional, i.e., diacid compounds and diols are used to prepare substantially linear polyester diols, although minor amounts of mono-functional, trifunctional, and higher functionality materials (perhaps up to 5 mole percent) can be included to provide a slightly branched, but uncrosslinked polyester component. Suitable dicarboxylic acids include, without limitation, glutaric acid, succinic acid, malonic acid, oxalic acid, phthalic acid, hexahydrophthalic acid, adipic acid, maleic acid, their anhydrides and polymerizable esters (e.g., methyl esters) and salts (e.g., chlorides), and mixtures of these. Suitable polyols include those already mentioned, especially the diols. In a preferred embodiment, the carboxylic acid includes adipic acid, phthalic acid or maleic acid (or the anhydrides or polymerizable esters of these) and the diol includes 1,4-butanediol, 1,6-hexanediol, or diethylene glycol. Typical catalysts for the esterification polymerization are protonic acids, Lewis acids, titanium alkoxides, and dialkyltin oxides.

A polymeric polyether or polycaprolactone diol reactant for preparing thermoplastic polyurethanes may be obtained by reacting a diol initiator, e.g., ethylene or propylene glycol, with a lactone or alkylene oxide chain-extension reagent. Lactones that can be ring opened by an active hydrogen are well-known in the art. Examples of suitable lactones include, without limitation, ε-caprolactone, γ-caprolactone, β-butyrolactone, β-propriolactone, γ-butyrolactone, α-methyl-γ-butyrolactone, β-methyl-γ-butyrolactone, γ-valerolactone, δ-valerolactone, γ-decanolactone, δ-decanolactone, γ-nonanoic lactone, γ-octanoic lactone, and combinations of these. In one preferred embodiment, the lactone is ε-caprolactone. Useful catalysts include those mentioned above for polyester synthesis. Alternatively, the reaction can be initiated by forming a sodium salt of the hydroxyl group on the molecules that will react with the lactone ring.

In other embodiments, a diol initiator may be reacted with an oxirane-containing compound to produce a polyether diol to be used in the polyurethane polymerization. Alkylene oxide polymer segments include, without limitation, the polymerization products of ethylene oxide, propylene oxide, 1,2-cyclohexene oxide, 1-butene oxide, 2-butene oxide, 1-hexene oxide, tert-butylethylene oxide, phenyl glycidyl ether, 1-decene oxide, isobutylene oxide, cyclopentene oxide, 1-pentene oxide, and combinations of these. The oxirane-containing compound is preferably selected from ethylene oxide, propylene oxide, butylene oxide, tetrahydrofuran, and combinations of these. The alkylene oxide polymerization is typically base-catalyzed. The polymerization may be carried out, for example, by charging the hydroxyl-functional initiator compound and a catalytic amount of caustic, such as potassium hydroxide, sodium methoxide, or potassium tert-butoxide, and adding the alkylene oxide at a sufficient rate to keep the monomer available for reaction. Two or more different alkylene oxide monomers may be randomly copolymerized by coincidental addition or polymerized in blocks by sequential addition. Homopolymers or copolymers of ethylene oxide or propylene oxide are preferred. Tetrahydrofuran may be polymerized by a cationic ring-opening reaction using such counterions as SbF₆⁻, AsF₆⁻, PF₆⁻, SbCl₆⁻, BF₄⁻, CF₃SO₃⁻, FSO₃⁻, and ClO₄⁻. Initiation is by formation of a tertiary oxonium ion. The polytetrahydrofuran segment can be prepared as a “living polymer” and terminated by reaction with the hydroxyl group of a diol such as any of those mentioned above. Polytetrahydrofuran is also known as polytetramethylene ether glycol (PTMEG). Preferred chain-extension reagents in making a polymeric polyether or polycaprolactone diol reactant are epsilon-caprolactone and tetrahydrofuran. In one preferred embodiment, the golf club base layer includes a polyurethane prepared by reacting a mixture comprising PTMEG, 1,4 butanediol, and 4,4′ diphenylmethane diisocyanate (MDI).

Aliphatic polycarbonate diols that may be used in making a thermoplastic polyurethane elastomer are prepared by the reaction of diols with dialkyl carbonates (such as diethyl carbonate), diphenyl carbonate, or dioxolanones (such as cyclic carbonates having five- and six-member rings) in the presence of catalysts like alkali metal, tin catalysts, or titanium compounds. Useful diols include, without limitation, any of those already mentioned. Aromatic polycarbonates are usually prepared from reaction of bisphenols, e.g., bisphenol A, with phosgene or diphenyl carbonate. Aliphatic polycarbonates may be preferred for a higher resistance to yellowing.

In various embodiments, the polymeric diol preferably has a weight average molecular weight of at least about 500, more preferably at least about 1000, and even more preferably at least about 1800 and a weight average molecular weight of up to about 10,000, but polymeric diols having weight average molecular weights of up to about 5000, especially up to about 4000, may also be preferred. The polymeric diol advantageously has a weight average molecular weight in the range from about 500 to about 10,000, preferably from about 1000 to about 5000, and more preferably from about 1500 to about 4000. The weight average molecular weights may be determined by ASTM D-4274.

The synthesis of an elastomeric polyurethane may be carried out by reacting one or more of the above polymeric diols, one or more compounds having at least two isocyanate groups such as the diisocyanates and polyisocyanates already mentioned, and, optionally, one or more chain extension agents. To make a thermoplastic elastomeric polyurethane, the polyisocyanate component, polymeric diol, and chain extension agents are preferably substantially di-functional.

Useful active hydrogen-containing chain extension agents generally contain at least two active hydrogen groups, for example, diols, dithiols, diamines, or compounds having a mixture of hydroxyl, thiol, and amine groups, such as alkanolamines, aminoalkyl mercaptans, and hydroxyalkyl mercaptans, among others. The molecular weight of the chain extenders preferably range from about 60 to about 400. Alcohols and amines are preferred. Examples of useful diols include those diols already mentioned. Suitable diamine extenders include, without limitation, ethylene diamine, diethylene triamine, triethylene tetraamine, and combinations of these. Other typical chain extenders are amino alcohols such as ethanolamine, propanolamine, butanolamine, and combinations of these. The dithiol and diamine reactants may also be included in preparing polyurethanes that are not elastomeric.

In addition to difunctional extenders, a small amount of a trifunctional extender such as trimethylol propane, 1,2,6-hexanetriol and glycerol, or monofunctional active hydrogen compounds such as butanol or dimethyl amine, may also be present. The amount of trifunctional extender or monofunctional compound employed may be, for example, 5.0 equivalent percent or less based on the total weight of the reaction product and active hydrogen containing groups employed when preparing a thermoplastic polyurethane.

The polyurethane may be bio-based, for example as disclosed in U.S. Pat. No. 8,217,193, US Patent Application Publication No. 2008/0103340, US Patent Application Publication No. 2011/0155960, US Patent Application Publication No. 2010/0168371, US Patent Application Publication No. 2008/0081898, and PCT Publication WO08/022287, all of which are incorporated herein by reference in their entireties.

The reaction of the polyisocyanate, polymeric diol (if making an elastomeric polyurethane), and polyol or other chain extension agent is typically carried out at an elevated temperature in the presence of a catalyst. Typical catalysts for this reaction include organotin catalysts such as stannous octoate, dibutyl tin dilaurate, dibutyl tin diacetate, dibutyl tin oxide, tertiary amines, zinc salts, and manganese salts. Generally, for elastomeric polyurethanes, the ratio of polymeric diol, such as polyester diol, to extender can be varied within a relatively wide range depending largely on the desired hardness of the final polyurethane elastomer. For example, the equivalent proportion of polyester diol to extender may be within the range of 1:0 to 1:12 and, more preferably, from 1:1 to 1:8. Preferably, the diisocyanate(s) employed are proportioned such that the overall ratio of equivalents of isocyanate to equivalents of active hydrogen containing materials is within the range of 0.95:1 to 1.10:1, and more preferably, 0.98:1 to 1.04:1. The polymeric diol segments typically are from about 35% to about 65% by weight of the polyurethane polymer, and preferably from about 35% to about 50% by weight of the polyurethane polymer.

In various embodiments, the base layer or coating may include one or more thermoplastic or thermoset polyureas. Suitable polyureas may be prepared by reaction of one or more polyamines with one or more of the polyisocyanates already mentioned. Nonlimiting examples of suitable polyamines include diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), N-(3-aminopropyl)-N-methyl-1,3-propanediamine), 1,4-bis(3-aminopropoxy)butane, diethyleneglycol-di(aminopropyl)ether), 1-methyl-2,6-diamino-cyclohexane, 1,4-diamino-cyclohexane, poly(oxyethylene-oxypropylene)diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, polytetramethylene ether diamines, 3,3′,5,5′-tetraethyl-4,4′-diamino-dicyclohexylmethane (i.e., 4,4′-methylene-bis(2,6-diethylaminocyclohexane)), 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N.sub.3-amine), glycerin-based triamines, tetramines such as N,N′-bis(3-aminopropyl)ethylene diamine, triethylene tetramine; unsaturated diamines such as 4,4′-diamino-diphenylmethane (i.e., 4,4′-methylene-dianiline or “MDA”). Aromatic amines are not preferred because of a greater tendency to yellow. The amine- and hydroxyl-functional extenders already mentioned may be used as well. Generally, as before, trifunctional reactants are limited unless a thermoset polymer is desired.

In various embodiments, the base layer or coating may include one or more polyamides. Suitable polyamides may be obtained by: (1) polycondensation of (a) a dicarboxylic acid, such as oxalic acid, adipic acid, sebacic acid, terephthalic acid, isophthalic acid, 1,4-cyclohexanedicarboxylic acid, or any of the other dicarboxylic acids already mentioned with (b) a diamine, such as ethylenediamine, tetramethylenediamine, pentamethylenediamine, hexamethylenediamine, or decamethylenediamine, 1,4-cyclohexanediamine, m-xylylenediamine, or any of the other diamines already mentioned; (2) a ring-opening polymerization of a cyclic lactam, such as -caprolactam or -laurolactam; (3) polycondensation of an aminocarboxylic acid, such as 6-aminocaproic acid, 9-aminononanoic acid, 11-aminoundecanoic acid, or 12-aminododecanoic acid; or (4) copolymerization of a cyclic lactam with a dicarboxylic acid and a diamine. Polymerization may be carried out, for example, at temperatures of from about 180° C. to about 300° C. Specific examples of suitable polyamides include NYLON 6, NYLON 66, NYLON 610, NYLON 11, NYLON 12, copolymerized NYLON, NYLON MXD6, and NYLON 46. Thermoplastic elastomer amides, such as polyether-block-amides, may be used. Polyether-block-amides may be formed by esterifying dicarboxylic acid-terminated amides with polyoxyalkylene glycols. If a thermoset polyamide is desired, the reactants include a sufficient amount of trifunctional or higher reactants.

The base layer or coating may include any combination of the polyurethane, polyurea, and polyamide polymers themselves and any blends and copolymers of these with one another or with other copolymerized polymer blocks. The base layer or coating may also include any thermoset materials prepared from any of these.

In various embodiments, the base layer includes one or more of polyurethanes, polyureas, and polyamides and is dyed with the acid dye. The base layer may include another resin in addition to the polyurethane, polyurea, or polyamide such as, for example, polyester resin or thermoplastic elastomers, for example polyester or styrene-block copolymer thermoplastic elastomers, as long as such resins are compatible with the polyurethane, polyurea, or polyamide and do not prevent the base layer from being dyed. The base layer preferably includes 50 percent by weight or more, preferably 60 percent by weight or more, or 70 percent by weight or more of the polyurethane, polyurea, or polyamide or some combination of more than one polyurethane, polyurea, and polyamide resin.

Ionomers are typically not compatable with polyurethanes. Also, due to the acid content in the ionomers, the ionomers may interfere with the dyeing process and are not preferred when the base layer is to be dyed. However, when the coating layer is dyed, the base layer may include an ionomer resin. Examples of ionomer resin that may be used include copolymers of ethylene, an α,β-ethylenically unsaturated acid having 3 to 8 carbon atoms, and optionally an ester of an α,β-ethylenically unsaturated acid having 3 to 8 carbon atoms that are at least partially neutralized with a metal ion. Examples of the ethylenically unsaturated acid include acrylic acid, methacrylic acid, crotonic acid, fumaric acid, and maleic acid; in particular, acrylic acid and methacrylic acid may be preferred. Examples of the α,β-ethylenically unsaturated esters include the methyl, ethyl, propyl, isopropyl, butyl, isobutyl, tert-butyl, amyl, and hexyl esters of acrylic acid, methacrylic acid, crotonic acid, fumaric acid, and maleic acid; in particular, acrylates and methacylates are useful. The neutralizing metal ion may be, for example, monovalent metal ions such as sodium, potassium, and lithium ions; divalent earth metal ions such as magnesium, calcium, zinc, and barium; and other metal ions such as aluminum, zirconium, and tin, with sodium, zinc, and magnesium ions being among those preferred.

The base layer may be formulated with a pigment, such as a yellow or white pigment, and in particular a white pigment such as titanium dioxide or zinc oxide, an aluminum pigment, or a white pearlescent pigment such as titanium dioxide-coated mica pigments. White, silver metallic, and white pearl colors provide dyed second colors that are truest to the dye selected, but other first colors, particularly light colors such as a light yellow, can be used to create a different color with the dye. Generally, dark or intense first colors are avoided, but pigments of many colors may be used to provide light colors or for tinting, and special effect pigments may also be used as desired. Examples of other pigments that could be used include inorganic pigment such as red iron oxide, transparent red iron oxide, chromium oxide green, ferric ammonium ferrocyanide (Prussian blue), and ultramarine; organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, and naphthol orange; and flake pigments such as copper flake pigments, zinc flake pigments, stainless steel flake pigments, and bronze flake pigments, and iron oxide-coated mica pigments; and fluorescent or phosphorescent pigments such as zinc sulfide, cadmium sulfide, and metal aluminate phosphorescent pigments. Generally titanium dioxide is used as a white pigment, for example in amounts of from about 0.5 parts by weight or 1 part by weight to about 8 parts by weight or 10 parts by weight passed on 100 parts by weight of resin. In various embodiments, a white-colored base layer may be tinted with a small amount of blue pigment or brightener.

The base layer may also contain one or more customary additives such as fillers, dispersants, hindered amine light stabilizers such as piperidines and oxanalides, ultraviolet light absorbers such as benzotriazoles, triazines, and hindered phenols, antioxidants such as phenols, phosphites, and hydrazides, plasticizers, defoaming agents, processing aids, surfactants, fluorescent materials and fluorescent brighteners, and so on. Examples of suitable inorganic fillers include zinc oxide, zinc sulfate, barium carbonate, barium sulfate, calcium oxide, calcium carbonate, clay, tungsten, tungsten carbide, tin oxide, zinc carbonate, silica, talc, clays, glass fibers, and natural fibrous minerals. Suitable organic fillers may include melamine colophony, cellulose fibers, polyamide fibers, polyacrylonitrile fibers, polyurethane fibers, or polyester fibers. Polymeric, ceramic, metal, and glass microspheres also may be used. Combinations of any of these may be used. Fillers may be used to adjust the specific gravity, modulus, and other physical properties of the base layer. The total amount of the filler may be from about 0.5 to about 30 percent by weight of the polymer components. Wetting or dispersing additives may be used to more effectively disperse the pigments and particulate fillers. Generally, the additives will be present in the composition in an amount between about 1 and about 70 weight percent based on the total weight of the composition depending upon the desired properties.

In another aspect, the base layer is coated with a clear coating layer that contains a polyurethane, polyamide, or polyurea as described, or some combination of these and that is dyed in the process. In this case, the base layer may also contain a polyurethane, polyamide, or polyurea or it may contain none of these and instead include one of the other polymers mentioned above.

Besides the polyurethane, polyamide, or polyurea, the clear coating layer may include one or more customary additive, such as a hindered amine light stabilizer, ultraviolet light absorber, antioxidant, or plasticizer.

Typically, the coating layer may have a thickness of from about 5 μm to about 100 μm. In various embodiments, the coating layer may be from about 5 μm or about 10 μm or about 15 μm to about 100 μm or about 75 μm or about 50 μm or about 25 μm or about 20 μm thick.

### Example

General procedures for preparing dye solutions for dyeing polymeric polymeric portions of golf clubs are as follows. A pre-determined amount of dye is added to deionized water and alcohol mixture. The dye is dissolved by heating the solution to a temperature of from about 40° C. to about 70° C. with agitation. Upon dissolution, an ammonium salt is added either as a solid or in the form of a concentrated aqueous solution. A golf club having a thermoplastic polyurethane base layer is prewashed by washing the polymeric portion 12 for about 5 minutes in a mixture of 60% by volume of n-propanol and 40% by volume deionized water, which may be heated to a temperature up to 70° C., then drying the polymeric portion 12. After the desired temperature of the dye solution is reached, the pre-washed golf club is placed in the dye bath for from about 2 to about 10 minutes. The dye solution temperature and the dye time can be adjusted to obtain a desired color intensity. The dyed golf club is removed, rinsed with tap water or a solution of up to 20% n-propanol with tap or deionized water, and dried by air.

Typical dye solutions are composed of 15% by weight of n-propanol and 85% by weight of DI water but could contain a higher concentration of n-propanol. Into the n-propanol/water solution are added powdered dye and TBAC (tetrabutyl ammonium chloride) in a ratio of 1 or 2 parts dye to 1 part TBAC. Nonionic disperse dyes require no TBAC (luminous yellow for instance).

### Golf Club Customization

FIG. 2 provides a method 100 of customizing a golf club 10 according to a user-specified color scheme. The method 100 begins at 102 by providing a stock golf club 10 having a plurality of polymeric portions 12, where each of the plurality of polymeric portions 12 are colored a predetermined base color. In one configuration, the base color is a light color, such as white, grey, ivory, light yellow, or the like. In one configuration, the base color may include a metallic flake or pearlescent additive for additional effect.

As noted above, each polymeric portion 12 may include, for example, a polymeric insert that is bonded to, or mechanically interlocked with the remainder of the club head 10, a polymeric portion of the club head 10 itself, or a polymeric paint or coating that is applied to a metallic or non-metallic portion of the club head 10 during the finishing stages of manufacturing. The polymeric portion 12 may include at least one of polyurethane, polyurea, and polyamide in an amount sufficient to be dyed with an acid or nonionic disperse dye. Examples of suitable materials are noted above.

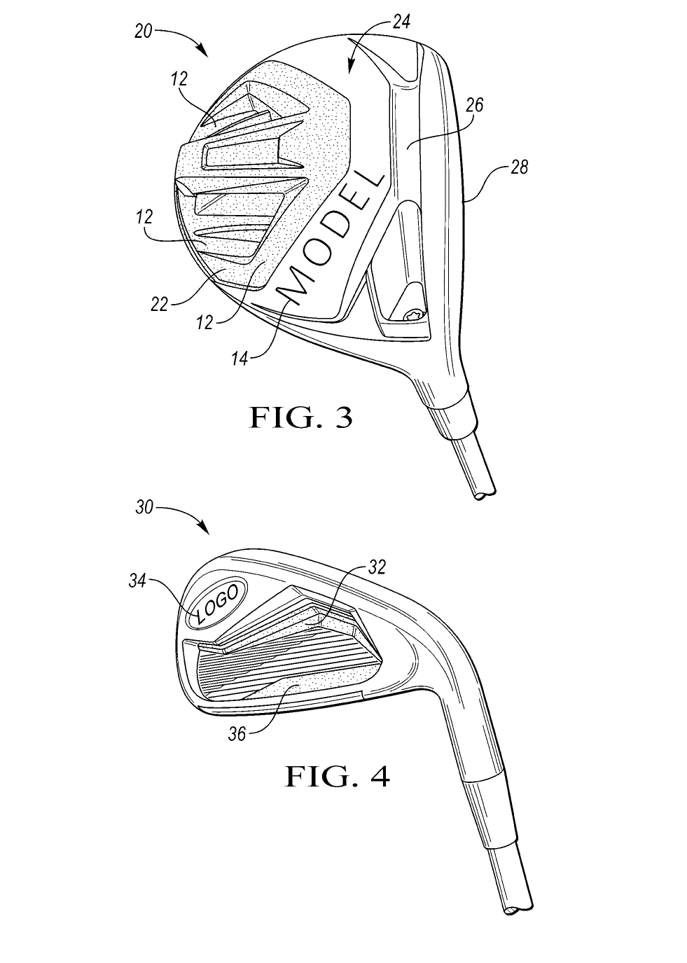

FIGS. 3-6 illustrate different club designs and examples of possible polymeric portions 12. FIG. 3 illustrates a wood-type golf club 20, such as a driver 20. As shown, the driver 20 includes a polymeric insert 22 provided in the sole 24 of the club head. The driver 20 further includes a model name formed from a plurality of grooves 14 formed in the metal club body, with each groove being filled with a polymeric fill-paint. Finally, the driver 20 includes a polymeric portion 12 as a painted transition zone or “compression channel” 26, located immediately rearward of the face 28. Other examples of polymeric portions that may be dyed according to these methods may include polymeric coatings on the crown of the club head 10 and paint-filled grooves on the face of the club.

FIG. 4 illustrates a cavity-back iron-type club head 30 that includes a polymeric filler material 32 secured within a cavity/void provided in the rear of the club head 10. Additionally, the club head 30 includes a logo 34 and a painted portion 36 of the rear surface. Each of the filler material 32, logo 34, and painted portion 36 may be formed from a polymeric material that is suitable to be dyed according to the present methods.

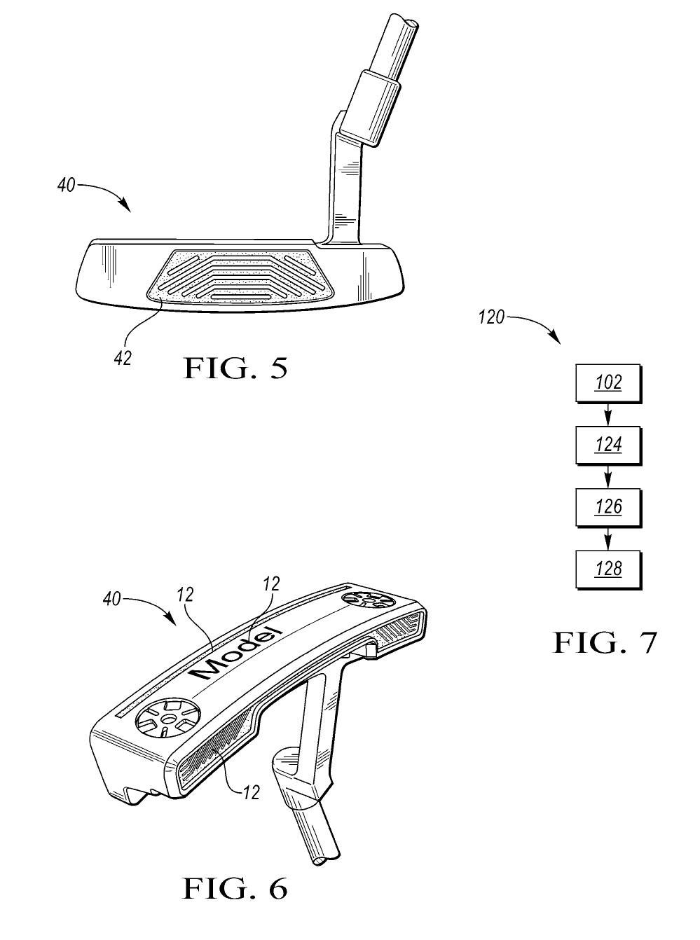

FIG. 5 illustrates a putter head 40 having a polymeric face insert 42 that may be dyed according to the current methods. Likewise, FIG. 6 illustrates a reverse angle of the putter head 40 of FIG. 5, where a plurality of other polymeric portions 12 are also visible.

Once a golf club head having one or more polymeric portions 12 is provided, a customized color scheme may be received at 104, where the customized color scheme identifies an intended final color for each of the one or more polymeric portions 12.

One example of a method 120 for receiving a customized color scheme is illustrated in FIG. 7. As shown in FIG. 7, in a first step 122, a user is provided with a visual representation of a golf club head with all dyeable polymeric portions identified. Such a providing step may be enabled, for example, via an internet webpage or mobile device application. The user may also be provided with a predefined set of color choices at 124, where the user may associate one or more of the color choices with each of the respective one or more polymeric portions 12 (at 126). As the color of each polymeric portion 12 is specified, the webpage or app may render the club head with the chosen color at 128. Once the color of each respective polymeric portion has been specified, the application may consolidate all of the color selections into a data file (i.e., representing the customized color scheme), which may be transmitted to, and/or received by a customization server.

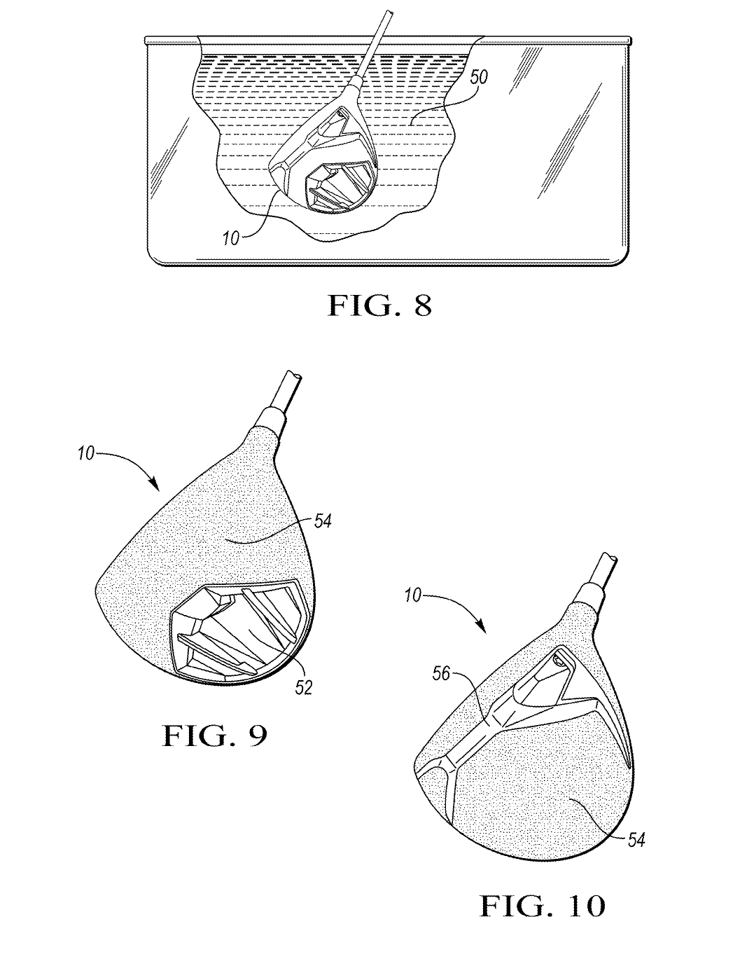

Referring again to FIG. 2, once the customized color scheme is received at 104, if only a single color is specified for all of the polymeric portions 12, an acid dye of the specified color is applied to the club head at 106. As shown in FIG. 8, this application may occur by immersing the golf club head 10 partially or fully in the dye solution 50 for a predetermined period of time. In other configurations, the application of the dye to the club head 10 may occur by other means such as spraying or printing. As discussed above, the predetermined period of time may be selected to achieve the desired degree of coloration.

If the customized color scheme specifies different colors for different sections or features of the club head 10 then the dyeing of each section/feature may be performed in an iterative or sequential manner. More specifically, at 108 the club head 10 may be masked such that only a first polymeric portion 52 of the club head 10 is exposed, as generally illustrated in FIG. 9. The masking 54 may utilize a stencil or other aqueous barrier to prevent the dye solution 50 from contacting all but a first polymeric portion 52.

Referring again to FIG. 2, at 110 a first dye solution 50 may be applied to the club head 10 for a predetermined period of time to dye the first polymeric portion 52 a first color. This application may occur by immersing the club head 10 in the dye 50 or by other means such as spraying or printing. If it is determined that additional colors remain to be applied (at 112), then the masking 54 may be reconfigured at 114 to expose a second polymeric portion 56 of the club head 10, such as shown in FIG. 10. A second dye solution may then be applied to the club head 10 to dye the exposed second polymeric portion 56 to a second color. This process may continue until all polymeric portions that are specified in the color scheme are sufficiently dyed.

In one configuration, after all polymeric portions are dyed according to the customized color scheme, the polymeric portions may optionally be coated with a clear coating layer at 116 to provide a high gloss shine or to alter one or more mechanical characteristics of the dyed surface. Following this, the customized club/club head may be provided to the user at 118.

In one embodiment, the dyeing process may occur prior to the retail sale of the club. For example, it may be performed at a manufacturing facility where the club is assembled, or it may occur closer (in the supply chain) to the end customer, such as at a national or regional distribution facility or retail establishment.

In an alternate embodiment, the dying techniques described in steps 106, 108, 110, 112, and 114 may be performed by a user following a retail sale. In such an instance, the user may be provided with a kit of parts that may be used to dye one or more polymeric portions of a golf club head 10 to one or more desired colors. The kit of parts may include masking material, and a dye solution that is adapted to dye the one or more polymeric portions of the golf club head 10. The masking material may include preformed masks that may be secured to the club head 10 in such a manner to only permit one polymeric portion to be exposed. If the golf club head includes multiple polymeric portions, then the kit may include, for example, multiple masking materials that may be used alone or in combination to expose only intended polymeric portions of the club head 10. The kit may further include instructions for preparing the dye solution and/or club head, and for performing the dying process.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. The terms “comprises,” “comprising,” “including,” and “having,” are inclusive and therefore specify the presence of stated items, but do not preclude the presence of other items. As used in this specification, the term “or” includes any and all combinations of one or more of the listed items. When the terms first, second, third, etc. are used to differentiate various items from each other, these designations are merely for convenience and do not limit the items. Finally, the terms “acid dye” and “anionic dye” are used interchangeably throughout the description and claims.

1. A method of providing a customized color scheme on a golf club head, the method comprising:
providing a golf club head comprising a polymeric material selected from the group consisting of polyurethanes, polyureas, polyamides, and combinations thereof; and
contacting the polymeric material with an aqueous anionic or nonionic disperse dye solution to dye the polymeric material from a first color to a second color.

2. The method of claim 1, further comprising applying a coating over the polymeric material after it is dyed.

3. The method of claim 2, wherein the coating has a hardness that is greater than a hardness of the polymeric material.

4. The method of claim 3, wherein the polymeric material is disposed on a sole of the golf club head.

5. The method of claim 1, wherein the golf club head includes a first polymeric portion and a second polymeric portion, each respectively including the polymeric material; and
wherein the method further comprises masking the second polymeric portion prior to contacting the first polymeric portion with the aqueous anionic or nonionic disperse dye solution.

6. The method of claim 5, further comprising masking the first polymeric portion after the first polymeric portion is dyed; and
contacting the polymeric material of the second polymeric portion with a second aqueous anionic or nonionic disperse dye solution to dye the second polymeric portion a color that is different than the first polymeric portion.

7. The method of claim 1, wherein contacting the polymeric material with the aqueous anionic or nonionic disperse dye solution includes immersing the golf club head partially or fully in the dye solution.

8. The method of claim 1, wherein the golf club head includes a plurality of polymeric portions, each respectively including the polymeric material; and
further comprising receiving a customized color scheme from a user, wherein the customized color scheme identifies an intended final color for each of the plurality of polymeric portions.

9. The method of claim 8, further comprising:
providing a visual representation of a golf club head to a user, the visual representation having plurality of sections, each respectively corresponding to one of the plurality of polymeric portions of the golf club;
providing a predefined plurality of color choices to the user; and
wherein receiving a customized color scheme from a user includes receiving an indication of a color choice, selected from the plurality of color choices, for each one of the plurality of sections; and
generating a data file representative of the customized color scheme.

10. The method of claim 1, wherein the dye solution comprises an acid dye compound and a quaternary ammonium compound which is a tetraalkylammonium compound selected from soluble tetrabutylammonium compounds and tetrahexylammonium compounds.

11. The method of claim 10, wherein the tetraalkylammonium compound comprises a bromide or a chloride.

12. The method of claim 11, wherein the tetraalkylammonium compound comprises a member selected from the group consisting of tetrabutylammonium bromide and tetrabutylammonium chloride.

13. The method of claim 1, wherein the dye solution further comprises from about 1% by volume to about 50% by volume of a water-soluble organic solvent.

14. The method of claim 1, wherein the dye solution comprises from about 0.001 to about 5.0 g/L of the acid dye compound.

15. The method of claim 1, wherein the polymeric material includes:
a polymeric fill, paint, or coating that is provided in a recessed groove or on an area of the club head;
a polymeric insert or applique that is mechanically or chemically affixed to the club head; or
a comolded portion of the club head.

16. A golf club comprising:
a golf club head including a polymeric material selected from the group consisting of polyurethanes, polyureas, polyamides, and combinations thereof; and
wherein the polymeric material is dyed to a predetermined color by contacting the polymeric material with an aqueous anionic or nonionic disperse dye solution to dye the polymeric material.

17. The golf club of claim 16, wherein the polymeric material is:
a polymeric fill, paint, or coating that is provided in a recessed groove or on an area of the club head;
a polymeric insert or applique that is mechanically or chemically affixed to the club head; or
a comolded portion of the club head.

18. The golf club of claim 16 further comprising a coating disposed over the dyed polymeric material; wherein the coating has a hardness that is greater than a hardness of the polymeric material.

19. The golf club of claim 18, wherein the polymeric material is disposed on a sole of the golf club head.

20. The golf club of claim 16, wherein the polymeric material comprises a thermoplastic polyurethane.
